(19) United States
(12) Patent Application Publication
(10) Pub. No.: US 2009/0040122 A1
(43) Pub. Date: Feb. 12, 2009

(54) Rings and Harmonizer

(76) Inventors: Gary Spurling, Erie, CO (US); Katharina F. Spurling-Kaffl, Erie, CO (US)

Correspondence Address: PATENT LAW OFFICES OF RICK MARTIN, PC, PO BOX 1839, LONGMONT, CO, 80502, US

(21) Appl. No.: 12/188,061

(22) Filed: Aug. 7, 2008

Related U.S. Application Data
(60) Provisional application No. 60/954,474, filed on Aug. 7, 2007.

(51) Int. Cl. H01Q 1/36

(52) U.S. Cl. 343/718

(57) ABSTRACT

Rings of metal are made from combinations of multi-strands. Each ring starts as a strand with a length of either a sacred cubit (20.6 inches), lost cubit (23.49 inches) or a fraction thereof. A fraction could be a value greater or lower than the unit 1. A multi ring and coil device is named a harmonizer. Each device can be used as a simple antenna to propagate sound waves from speaker or other energy waves. In theory each device creates a free energy called ether, perhaps a by-product of a gravitational standing wave which may be evolving throughout all time and space. Applications for the antennas include the healing arts and pollution control.

### CROSS REFERENCE APPLICATIONS

This application is a non-provisional application claiming the benefits of provisional application No. 60/954,474 filed Aug. 7, 2007.

### FIELD OF INVENTION

The present invention relates to forming ancient sacred cubit length (20.6 inches) and lost cubit length (23.49 inches) metal strips into rings. See Wikipedia.org defining “cubit.” In theory in the center of each ring is formed a tensor plane also called a neutral space. This center may propagate 144 or 177 megahertz of light over a distance. In theory these rings interfere with a theoretical standing gravitational wave in the universe. In theory these ring formations have an effect on living organisms, weather and chemicals including water.

### BACKGROUND OF THE INVENTION

New physics theories include gravitation as an ubiquitous medium. Dr. Hartmut Müller (raum and zeit, Speciall, 2002, www.raum-und-zeit.com) predicts that the entire universe and all particles and living organisms are formed to be in harmony with a gigantic standing gravitational wave. Thus, the measured life span of a proton is at least 10²⁵ years, and that of an electron 10²². An analysis of atomic particle weight as well as living organism weights offers proof of acceptable and non-acceptable masses of all objects, even planets, in the universe. The explanation is the existence of a standing gravitational wave that, through evolution, wherein this wave shapes everything in the universe. “The wave has run through the universe many times, and it allows a long-term survival to only those physical objects who mass values ‘fit into the wave’.” Id. Page 10.

Other theories of as yet unexplained universal energies include string theories and morphogenetic fields. The theories postulate that all matter forms, forms of consciousness, planetary bodies, and human bodies are manifested through a morphogenetic (form-holding) imprint. This imprint exists as quantity of crystalline, electrotonal energetic substance that is composed of specific patterns of frequency (Keylonic Dictionary, www.keylonticdictionary.org). See also thirty-eight titles by John Archibald Wheeler, born 1911-present, including Geometrodynmics, 1957.

In this book Mr. Wheeler defines a tensor as being formed by a single loop of wire, a ring. The tensor is allegedly visible in dim light, appearing as a faint light emitting area in the open space of the ring.

The present invention provides various embodiments of rings which allegedly create tensors. The theory is that scalar wave patterns are transmitted by these rings that can allegedly effect health, chemical properties and weather patterns when used as an antenna coupled to sound waves.

### SUMMARY OF THE INVENTION

The basis of the technology is prior art. (See: GEOMETRODYNAMICS, by John Archibald Wheeler, 1957.) In this work he described a tensor as being formed by a simple loop of wire. The tensor is visible in dim light, appearing as a faint light emitting area in the open space of the ring. As of the publication of his work no practical application was known and the mathematical descriptions were part of a larger text and theoretical mathematics in the context of quantum physics.

In the current invention physical embodiments are known as the Light-Life™ Technology. The precise measurements are found in ancient cultures in variously encoded forms and under the generally accepted name of cubit and neter.

We have found through research that two of the different cubit lengths, when formed into rings have natural resonant frequencies of 144 (sacred) and 177 (lost) MHz, respectively. These frequencies and associated wavelengths are directly and harmonically related to a wide range of natural physical constants found in mathematics and physics. In addition, a range of at least six sub-harmonics are seen on the oscilloscope.

The technology in all embodiments is activated and amplified by any known source of frequency from acoustic to light, and transmits that frequency directionally as a transitional scalar wave. There is no detectable EMF or RF signal transmission. The technology converts volts to amps with zero voltage and also converts digital signals to analog.

It has been found that the various embodiments have alleged application in the healing arts.

It was recently discovered that if the basic twisted wire configuration was annealed and hammered, not rolled, flat, that the effect in the healing arts are significantly greater with apparently enhanced qualities.

Further research indicates that folding the initial twisted length and twisting again, (double twist) amplifies the effects further. Further, hammering this double twist yields another significant increase in effect.

The effects observed are a result of the transitional scalar wave field produced by the tensor created by the various embodiments. The flattened embodiment produces a stronger, coherent scalar field, frequency modulated in wavelengths and amplitudes which are compatible with, and supportive of, normalizing processes in living tissue.

In all embodiments, the lengths of employed cubits/neters are significant. Multiples and sub-multiples, pi and phi ratios are employed to maintain the appropriate frequencies for physical compatibilities with living tissue.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 (prior art) is a top plan view of a single twisted pair of metal wires made into a ring.

FIG. 2a is a top plan view of two twisted pairs of metal wires.

FIG. 2b is a top plan view of the two twisted pairs of metal wires in FIG. 2a wound into a double twisted pair length of wire.

FIG. 2c is a top plan view of the double twisted pair length of wire from FIG. 2b made into a ring.

FIG. 3a is a top plan view of a single twisted pair of wires that have been flattened.

FIG. 3b is a top plan view of a ring made of the FIG. 3a flattened strand.

FIG. 3c is a side perspective view of the ring shown in FIG. 3b.

FIG. 4a is a top plan view of a flattened strand of the double twisted pair strand shown in FIG. 2b.

FIG. 4b is a top plan view of a ring made from the flattened strand shown in FIG. 4a.

FIG. 4c is a side perspective view of the ring shown in FIG. 4b.

FIG. 5a is a side perspective view of a twisted pair, flattened finger sized ring.

FIG. 5b is a side perspective view of a finger sized ring using two different metals.

FIG. 5c is a side perspective view of a finger sized ring using three strands, and two different metals.

FIG. 6a is a side perspective view of a two strand, flattened loop ring.

FIG. 6b is a top plan view of the strand used to make the ring of FIG. 6a.

FIG. 7 (prior art) is a side perspective view of a three ring globe with a center coil, the device is called a harmonizer.

FIG. 8 is a top perspective view of a harmonizer having a top loop for support from a string.

FIG. 9 is a side perspective view of a harmonizer used as a transmitting antenna for sound waves.

FIG. 10 is a side perspective view of a harmonizer assembly with an inner harmonizer having a sacred cubit measurement, and an outer harmonizer having a lost cubit measurement.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

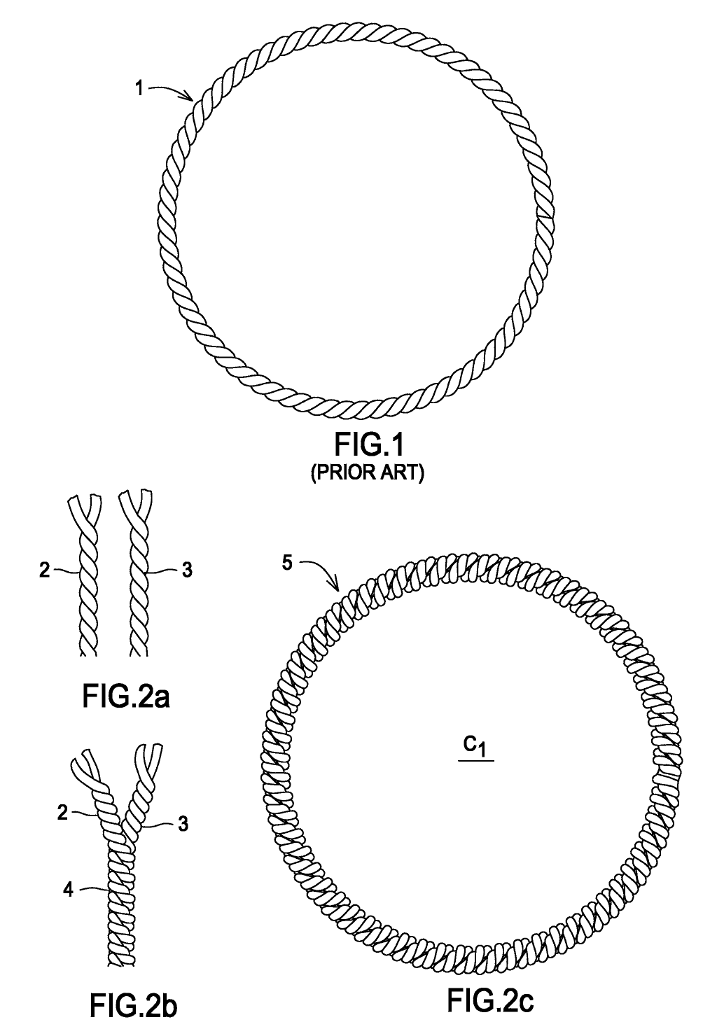

FIG. 1 (prior art) is a ring made from a twisted metal pin strand which can measure either one sacred cubit (20.6 inches) with a resonant frequency of 144 MHz or one lost cubit (23.49 inches) with a resonant frequency of 177 Mhz. The theory is described in Slim Spurling's Universe, by Cal Garrison© 2004, page 102 et seq. In an electrical circuit when a dead short is created, there is a zero voltage (pressure) but an infinite amount of current. Rings (of proper size) are analogous to superconductors of an energy field called ether. This energy field may be a result of a gigantic standing wave of gravity pulsing throughout the entire universe.

The ring 1 in theory creates a large current of ether at no voltage. The ring unleashes a source of (little understood as yet in modern science) free energy. Copper works fine, and gold or silver platings can be used.

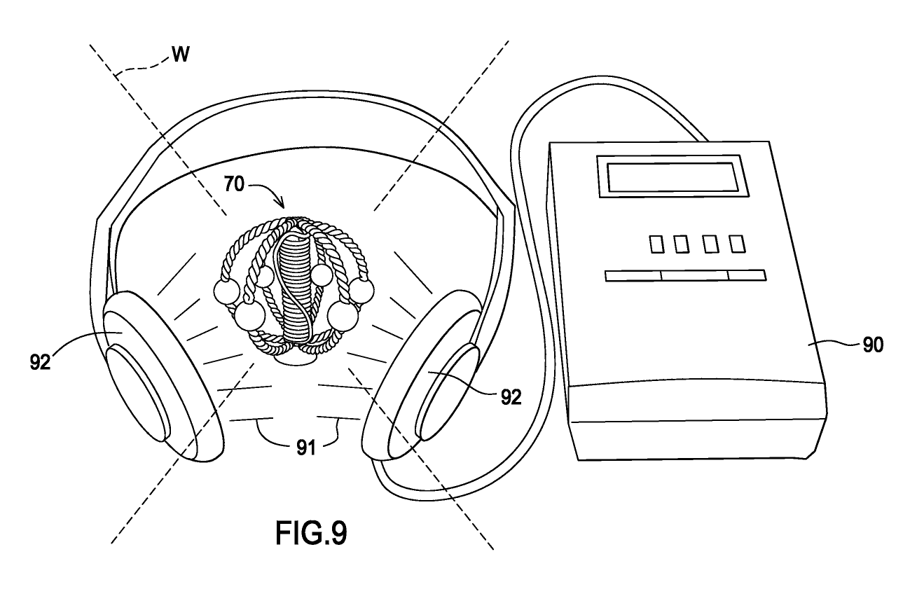

FIGS. 2a-2c show two pair of twisted metal strand wires 2 and 3. The wires 2 and 3 are then wound into a double twisted pair strand 4 of a specified length of either a sacred cubit (20.6 inches) or a lost cubit (23.49 inches) or a multiple or a fractional length of a sacred or lost cubit, such as a double cubit or a half cubit strand made into a ring. The ether energy in theory at the ring 5 center C₁ is greater than at the center of ring 1 of FIG. 1. It can be used as an antenna for sound waves, see FIG. 9. It can be used for a variety of antenna uses such as radio.

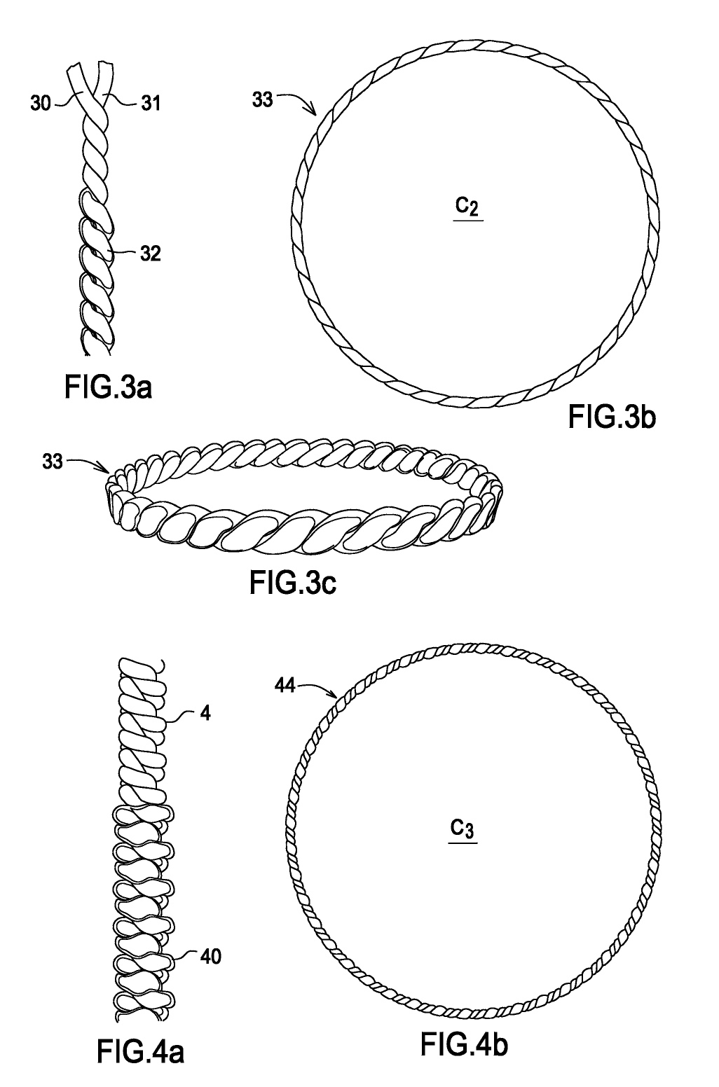

Referring next to FIGS. 3a-3c a twisted pair of wires are flattened into a strand 32 (of a either a sacred or lost cubit or fractional length thereof). The ring 33 has a center C2 which in theory exhibits a free energy field of ether.

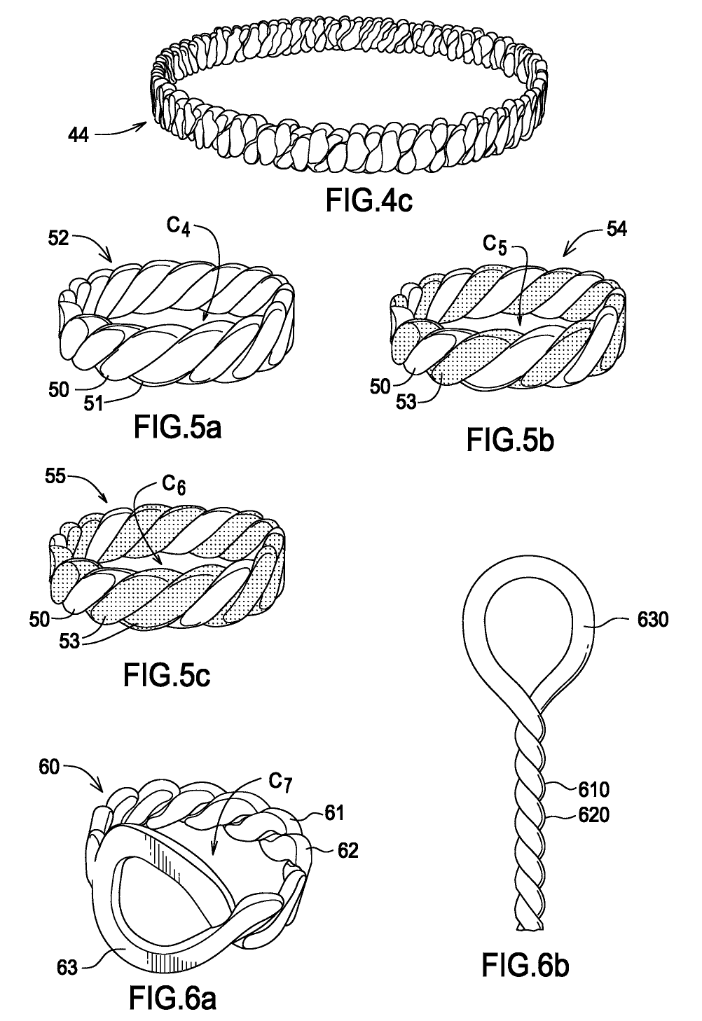

Referring to FIGS. 4a, 4b, 4c the double twisted pair strand 4 of FIG. 2b has been flattened into strand 40 (of a either a sacred or lost cubit or fractional length thereof) and then made into a ring 44 with center C3. Ring 44 has a unique antenna characteristics and, in theory, unique ether energy generating characteristics.

In FIG. 5a a (finger sized if desired) ring 52 is made of a twisted pair of metal wires 50, 51 which have been flattened. The length of strand 50, 51 before formation into a ring was either a sacred or lost cubit or a fraction thereof. The center C4 of ring 52 in theory has ether energy generation characteristics, and the ring 52 is a unique antenna for a wide range of electromagnetic and or electro-gravitational waves.

In FIG. 5b wire 53 is a different metal than wire 50. For example wire 50 could be silver and wire 53 copper. The center C5 of ring 54 exhibits unique antenna characteristics and in theory generates unique ether energy, or a lost cubit or a fraction thereof.

In FIG. 5c is shown ring 55 having three strands 50, 53 and 53. The center C6 exhibits unique antenna characteristics, and in theory generates unique ether energy. All the rings in this disclosure derive their straight line length from either a sacred cubit (20.6 inches) or a lost cubit (23.49 inches) or a fraction thereof.

Referring next to FIGS. 6a, 6b ring 60 has center C7 which creates unique antenna characteristics, and in theory a unique ether energy. Strands 610, 620, and loop 630 have been flattened to strands 61, 62, and loop 63.

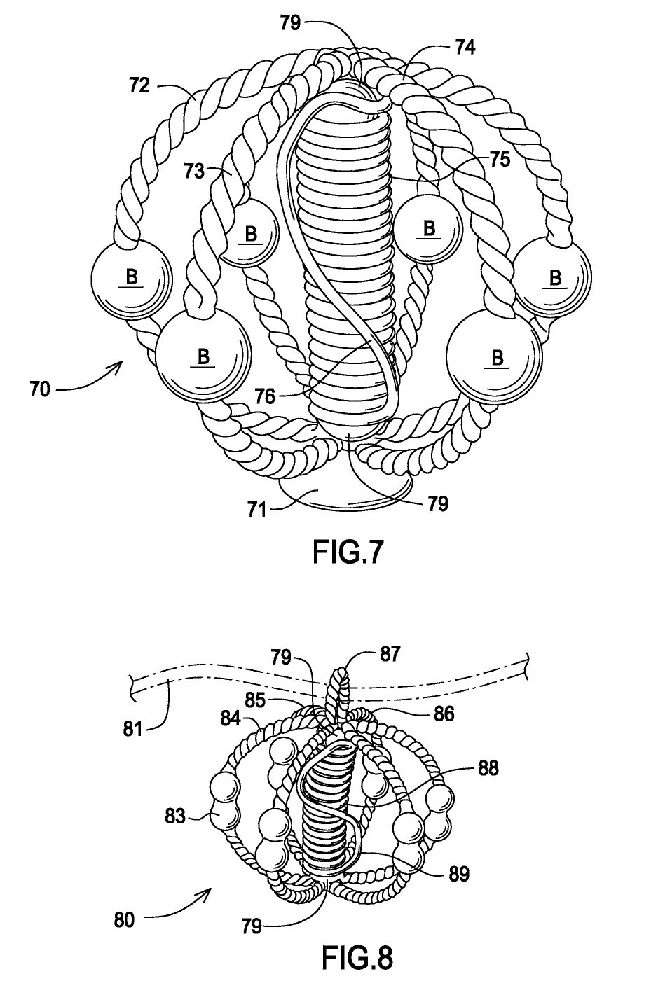

In FIG. 7 (prior art) a three ring device is labeled a harmonizer 70. A base 71 supports three double strand rings 72, 73 and 74. Each ring has metal bead B which is hollow. A central coil 75 is a cubit length (or fraction thereof) wound into coils and formed into a short circuit by connector 76. The central coil 75 is removable and held in place by beads 79 which are soldered to the confluence of rings 72, 73, 74. A lost cubit length is 23.49 inches with a resonant frequency of 177 MHz. It is believed that lost cubit harmonizers can act as amplifying antennas for thought waves, perhaps allowing a healer to “see” into the mind of a patient. The confluence of all the rings depicted creates a unique antenna, and in theory a super ether energy generator.

The rings 72, 73, 74 are spaced equidistant from each other.

In FIG. 8 a harmonizer 80 has a top support loop 87 which supports three rings 84, 85, 86 each of the same length and each ring having a double metal bead 83. The coil 88 is short circuited by connector 89 making it a continuous loop. String 81 can be used to support the harmonizer 80 from a user's neck. Harmonizer 80 is a unique antenna, and in theory creates a unique ether energy field. The rings 84, 85, 86 are spaced equidistant from each other.

Referring next to FIG. 9 the harmonizer 70 is shown used as a sound antenna generating waves W. A music generator 90 (nominally a tape recorder) produces sound waves 91 from headset speakers 92. These sound waves 91 are transmitted by antenna 70 to waves W, which in theory also contain ether waves that carry a great distance of several miles.

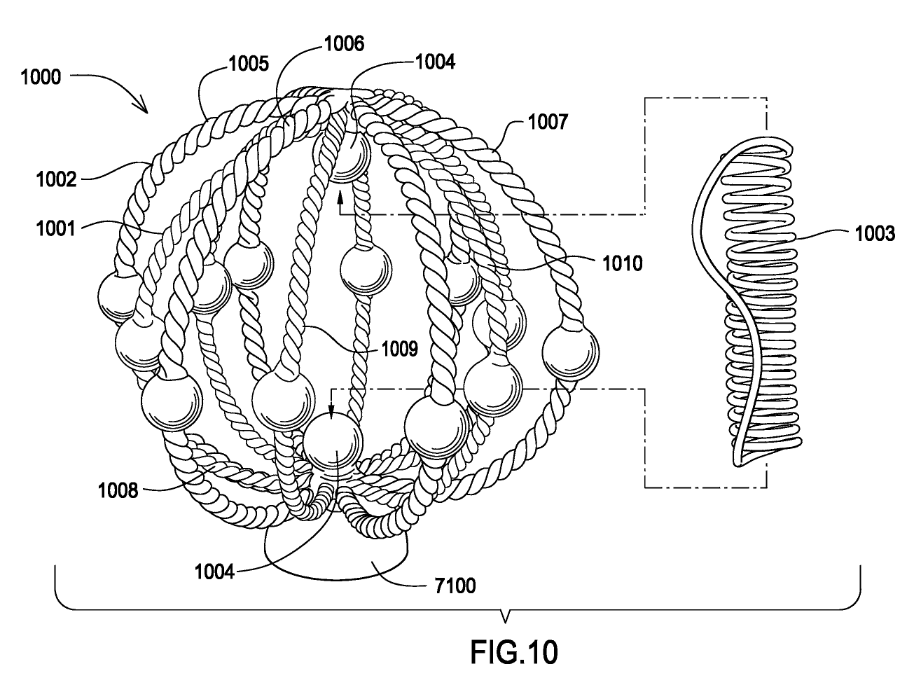

Referring next to FIG. 10, a harmonizer assembly 1000 consists of two harmonizers nested one inside the other. The inner harmonizer 1001 is preferably a sacred cubit measurement (or fraction thereof). The outer harmonizer 1002 is preferably a lost cubit. They share a removable central coil 1003 which is supported by beads 1004. Beads 1004 are soldered to the confluence of rings 1005, 1006, 1007 and 1008, 1009, 1010. Base 7100 is large enough to support the chosen size of the harmonizer assembly 1000.

Preferable sizes for the harmonizer assembly 1000 are ⅛, ¼, ½ and full cubits. In all embodiments, the lengths of employed cubits/neters are significant. Multiples and sub-multiples, pi and phi ratios are employed to maintain the appropriate frequencies for physical compatibilities with living tissue.

In forming the harmonizer assembly 1000, preferably copper components are first molded and soldered into the final structure. Then a silver coating is applied via electroplating. In making a ½ cubit harmonizer assembly 1000, the inner rings are 12 gauge copper, and the outer rings are 10 gauge copper. The beads are 12 mm diameter.

One use of the double harmonizer assembly is to amplify sound waves in an effort to reduce air pollution.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. An antenna comprising:
a first twisted pair of metal wires;
a second twisted pair of metal wires;
wherein the first twisted pair and the second twisted pair are twisted around one another into a strand;
said strand having a length of a cubit measurement or a multiple or a fractional length thereof; and
wherein the strand is formed into a circular ring.

2. The antenna of claim 1, wherein the stand is flattened.

3. An antenna comprising:
a twisted pair of metal wires;
wherein the twisted pair is flattened into a strand having a length of a cubit measurement or a multiple or a fractional length thereof; and
wherein said strand is formed into a circular ring sized to fit an adult human finger.

4. The antenna of claim 3, wherein the twisted pair of metal wires is made of a different metal for each strand.

5. The antenna of claim 4, wherein one metal is copper and the other metal is silver.

6. An antenna comprising:
a three wire twisted metal stand having a length of a cubit measurement or a multiple or a fractional length thereof;
two of the three wires made of a same metal with the third wire made of a different metal; and
wherein the strand is formed into a circular ring sized to fit an adult human finger.

7. An antenna comprising:
a metal wire twisted to form a loop and then further twisted into a twisted pair strand;
said twisted pair strand and said loop being flattened;
said twisted pair strand and loop having a length of a cubit measurement or a multiple or a fractional length thereof; and
wherein the twisted pair strand and loop is formed into a circular ring.

8. A double harmonizer antenna comprising:
an inner harmonizer having a sacred cubit measurement of fraction or multiple thereof and three rings equally spaced and connected at a top junction and a bottom junction;
each ring having a twisted wire pair construction;
a support bead mounted on the top junction and the bottom junction;
a central coil supported between the top and bottom beads;
said central coil having a wound spring construction with a top end connected to a bottom end forming a continuous loop; and
an outer harmonizer having a lost cubit measurement or fraction or multiple thereof and three outer rings equally spaced and connected at the top junction and bottom junction; and
wherein each outer ring has a twisted pair construction.

9. The apparatus of claim 8 further comprising a support base connected to the bottom junction.
